(19) United States
(12) Patent Application Publication
(10) Pub. No.: US 2017/0174806 A1
(43) Pub. Date: Jun. 22, 2017

(54) STYRENE-FREE THERMOSET RESINS

(71) Applicant: OREGON STATE UNIVERSITY, Corvallis, OR (US)

(72) Inventors: Kaichang LI, Corvallis, OR (US); Yili WU, Corvallis, OR (US)

(73) Assignee: Oregon State University, Corvallis, OR (US)

(21) Appl. No.: 15/127,766

(22) PCT Filed: Mar. 20, 2015
(86) PCT No.: PCT/US2015/021722

§ 371 Date: Sep. 20, 2016

Related U.S. Application Data
(60) Provisional application No. 62/057,940, filed on Sep. 30, 2014.
(60) Provisional application No. 61/968,981, filed on Mar. 21, 2014.

(51) Int. Cl. C08F 222/20; C08J 5/04

(52) U.S. Cl. CPC C08F 222/20; C08J 5/045; C08J 2335/02

(57) ABSTRACT

A reaction product of:
(a)) at least one cinnamyl alcohol or ester of cinnamic acid;
(b) at least one unsaturated polyester resin, at least one vinyl ester resin, or a mixture of an unsaturated polyester resin and a vinyl ester resin;
(c) at least one (meth)acrylated vegetable oil; and
(d) a free radical initiator system.

### CROSS REFERENCE TO RELATED APPLICATION

This application claims the benefit of the earlier filing date of U.S. Provisional Application No. 61/968,981, filed on Mar. 21, 2014, and the earlier filing date of U.S. Provisional Application No. 62/057,940, filed on Sep. 30, 2014. The contents of the prior applications are incorporated herein by reference in their entirety.

### BACKGROUND

Unsaturated polyester (UPE) resins and vinyl ester (VE) resins are two commonly used thermoset resins for fiber-reinforcing composites. They are widely used for production of a large variety of products with different properties for different applications such as automobile parts, boat hulls, oil tanks and pipes, and bath tubs. UPE resins are classified as polyesters containing carbon-carbon double bonds that participate in crosslinking reactions in the production of fiber-reinforced composites. The commonly used UPE resins are typically prepared from polymerization of the following three ingredients: 1) aromatic dibasic acids/esters/anhydrides such as phthalic anhydride, terephthalic acid, and isophthalic acid; 2) a diol such as ethylene glycol, 1,2-propylene glycol, and diethylene glycol; 3) a C═C containing dibasic acid/esters/anhydrides such as maleic anhydride and fumaric acid. The final properties of the composites such as water resistance, strength and brittleness can be tailored through changing the molar ratios of the three ingredients in the preparation of the UPE resins. The UPE resins are typically solid at a temperature below 50° C. and do not flow well for wetting reinforcing fibers such as glass fibers unless they are completely melted at a high temperature.

Vinyl ester resins are typically produced from reactions of epoxy resins with unsaturated carboxylic acid such as acrylic acid. The resulting products are then dissolved in a reactive diluent such as styrene.

### SUMMARY

Disclosed herein is a reaction product of:

(a) at least one cinnamyl alcohol or ester of cinnamic acid;

(b) at least one unsaturated polyester resin, or at least one vinyl ester resin, or a mixture of an unsaturated polyester resin and a vinyl ester resin;

(c) at least one (meth)acrylated vegetable oil; and

(d) a free radical initiator system.

Also disclosed herein is a reaction product of:

(a) at least one (meth)acrylated vegetable oil;

(b) at least one unsaturated polyester resin; and

(c) a free radical initiator system.

Additionally disclosed herein is a composition comprising:

(a) at least one (meth)acrylated vegetable oil;

(b) at least one unsaturated polyester resin; and

(c) a free radical initiator system.

Further disclosed herein is a composite comprising a fibrous material and the reaction product disclosed herein.

Also disclosed herein is a method for making a product comprising mixing together:

(a) at least one (meth)acrylated vegetable oil; and

(b) at least one unsaturated polyester resin in the presence of a free radical initiator system.

Further disclosed herein is a method for making a composite comprising combining:

(a) at least one (meth)acrylated vegetable oil;

(b) at least one unsaturated polyester resin;

(c) a free radical initiator system; and

(d) a fibrous material.

Additionally disclosed herein in one embodiment is a reaction product of:

(a) at least one cinnamyl alcohol or ester of cinnamic acid;

(b) at least one unsaturated polyester resin, or at least one vinyl ester resin, or a mixture of an unsaturated polyester resin and a vinyl ester resin; and

(c) a free radical initiator system.

Also disclosed herein is a composition comprising:

(a) at least one cinnamyl alcohol or ester of cinnamic acid;

(b) at least one unsaturated polyester resin, or vinyl ester resin, or a mixture of an unsaturated polyester resin and a vinyl ester resin; and

(c) a free radical initiator system.

Further disclosed herein is a method for making a product comprising contacting:

(a) at least one cinnamyl alcohol or ester of cinnamic acid;

(b) at least one unsaturated polyester resin, or at least one vinyl ester resin, or a mixture of an unsaturated polyester resin and a vinyl ester resin; and

(c) a free radical initiator system.

Additionally disclosed herein is a method for making a composite comprising combining:

(a) at least one cinnamyl alcohol or ester of cinnamic acid;

(b) at least one unsaturated polyester resin, or vinyl ester resin, or a mixture of an unsaturated polyester resin and a vinyl ester resin;

(c) a free radical initiator system; and

(d) a fibrous material.

Further disclosed herein is method for making a product comprising contacting:

(a) at least one cinnamyl alcohol or ester of cinnamic acid;

(b) at least one unsaturated polyester resin, or at least one vinyl ester resin, or a mixture of an unsaturated polyester resin and a vinyl ester resin;

(c) at least one (meth)acrylated vegetable oil; and

(d) a free radical initiator system.

Additionally disclosed herein is a method for making a composite comprising combining:

(a) at least one cinnamyl alcohol or ester of cinnamic acid;

(b) at least one unsaturated polyester resin, or vinyl ester resin, or a mixture of an unsaturated polyester resin and a vinyl ester resin;

(c) at least one (meth)acrylated vegetable oil;

(d) a free radical initiator system; and

(e) a fibrous material.

The foregoing will become more apparent from the following detailed description, which proceeds with reference to the accompanying figures.

### BRIEF DESCRIPTION OF THE DRAWINGS

FIG. 1 is a graph demonstrating the effects of the AESO content on the flexural properties of the composites. The strengths or moduli were significantly different from each other if the letters on top of error bars of any two groups are different. Flexural strength and flexural modulus data were statistically analyzed by one-way ANOVA and based on 95% confidence interval.

FIG. 2 is a graph demonstrating the effects of the AESO content on the tensile properties of the composites. The strengths or moduli were significantly different from each other if the letters on top of error bars of any two groups are different. Flexural strength and flexural modulus data were statistically analyzed by one-way ANOVA and based on 95% confidence interval.

FIG. 3 is a graph demonstrating the effects of the AESO content on the water absorption of the composites.

FIG. 4 is a graph of DSC curves of AESO60. (AESO60 (4000 ppm inhibitor) and AESO60 (8500 ppm inhibitor) represented AESO60 prepared from AESO containing 4000 and 8500 ppm monomethyl ether hydroquinone (MEHQ), respectively.)

FIG. 5 is a graph demonstrating the effects of temperatures on the resin viscosity (AESO60 and AESO resin contained 1.5 wt % of TBPB. UPE resin didn't contain TBPB)

FIG. 6 is a graph demonstrating the effects of temperatures on the pot life of AESO60.

FIG. 7 is a graph demonstrating the effects of the methyl cinnamate (MC) content on the flexural properties of the composites. The means between two groups significantly differ if the letters on top of error bars are different. Flexural strength and flexural modulus data were statistically analyzed by one-way ANOVA and based on 95% confidence interval.

FIG. 8 is a graph demonstrating the effects of the methyl cinnamate (MC) content on the tensile properties of the composites. The means between two groups significantly differ if the letters on top of error bars are different. Tensile strength and tensile modulus data were statistically analyzed by one-way ANOVA and based on 95% confidence interval.

FIG. 9 is a graph demonstrating the flexural properties of the fiberglass reinforced composites made from AESO/MC/UPE resin. (Flexural strength and flexural modulus data were statistically analyzed by permutation test using RStudio (RStudio, Inc., Boston, Mass.). All comparisons were based on a 95% confidence interval. The means between two groups significantly differ if the letters on top of error bars are different).

FIG. 10 is a graph showing the effects of the AESO/MC ratio on the viscosity of AESO/MC/UPE resins (Resins contained 60 wt % of (AESO+MC) and 40 wt % of UPE plastic, and no initiators).

### DETAILED DESCRIPTION

The C═C bonds in UPE resins are distributed along the polymer chains and cannot freely move around without carrying the polymer chains. There is considerable steric hindrance surrounding the C═C bonds when two C═C bonds try to collide with each other because both ends of the C═C bonds are linked to the polymer chains. The inability of the C═C bonds to freely move around and the steric hindrance make the reactions among the C═C bonds in the UPE resins very inefficient. As a result, the crosslinking/polymerization of UPE resins alone in the presence of a free radical initiator leads to weak and brittle polymeric matrixes containing substantial amounts of unreacted C═C bonds.

For the UPE resins to function as superior polymeric matrixes for fiber-reinforced composites, a reactive diluent has to be used with the UPE resins. An effective reactive diluent must meet the following requirements: 1) a mixture of a diluent, a UPE resin and a free radical initiator must have a low viscosity and is sufficiently stable, i.e., has a long enough pot-life at a working temperature so that the mixture can flow and wet reinforcing fibers for the production of the fiber-reinforced composites; 2) the diluent must have an activated C═C bond that can easily polymerize by itself and efficiently react with the C═C bonds in the UPE resins; 3) the reactive diluent itself must have a low viscosity, i.e., can freely move around at a working temperature, and is miscible with the UPE resins so that the activated C═C bonds in the diluent can have easy access to all C═C bonds in the UPE resins for the crosslinking/polymerization reactions. Styrene meets all these requirements. Styrene can dissolve the UPE resins very well to result in a mixture with a low viscosity at room temperature. Styrene is relatively inexpensive and can significantly improve the stiffness, strengths, water resistance, and thermal stability of the fiber-reinforced composites. Styrene is thus the most commonly used reactive diluent for the UPE resins. The commonly used styrene-UPE mixture can contain up to 60 wt % of styrene. Commercially available UPE resins are typically sold as liquid mixtures of styrene and UPE resins.

However, styrene is a flammable volatile organic compound (VOC) and a hazardous air pollutant (HAP), and was classified as a reasonably anticipated human carcinogen by the National Toxicology Program in 2011. The emission of styrene in the production and use of the styrene-UPE mixtures for production of fiber-reinforced composites may result in air pollution in the working environment and health issues for resin manufacturers and molders. Residual un-reacted styrene is typically present in the fiber-reinforced composites. It has been reported that the unreacted styrene could continue to emit during the lifetime of a fiber-reinforced composite product (U.S. Pat. No. 7,524,909). Governmental regulations on styrene emission have gradually tightened and compliance is becoming more difficult. The manufacturers of the UPE resins have been trying to reduce the styrene content in the styrene-UPE mixtures for the reduction of styrene emission. However, the reduction of the styrene content often leads to increased resin viscosity and inferior product properties. Besides styrene, (meth)acrylate monomers including methyl methacrylate (MMA) and butyl (meth)acrylate and styrene analogs including α-methylstyrene and 4-methylstyrene are also used as reactive diluents for the UPE resins in industry. However, they are not an ideal replacement for styrene because they are also volatile and hazardous chemicals.

It is desirable to develop non-volatile, non-toxic reactive diluents from renewable materials such as plant oils. Plant oils such as soybean oil have low volatilities and low viscosities, and are also inexpensive, abundant, renewable, and sustainable.

It is desirable to develop additional non-toxic reactive diluents. Methyl cinnamate, the methyl ester of cinnamic acid, is a natural product that is widely distributed in many plants and fruits such as Eucalyptus olida (also known as Strawberry Gum), strawberry, some varieties of pepper, and some varieties of basil. Methyl cinnamate is widely used as a food flavor and used in perfume industry.

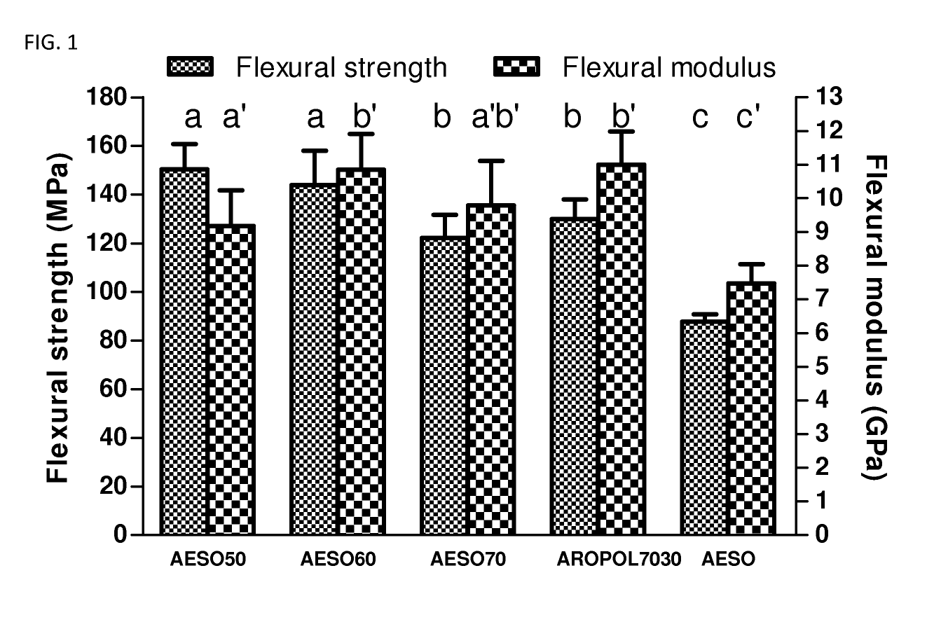

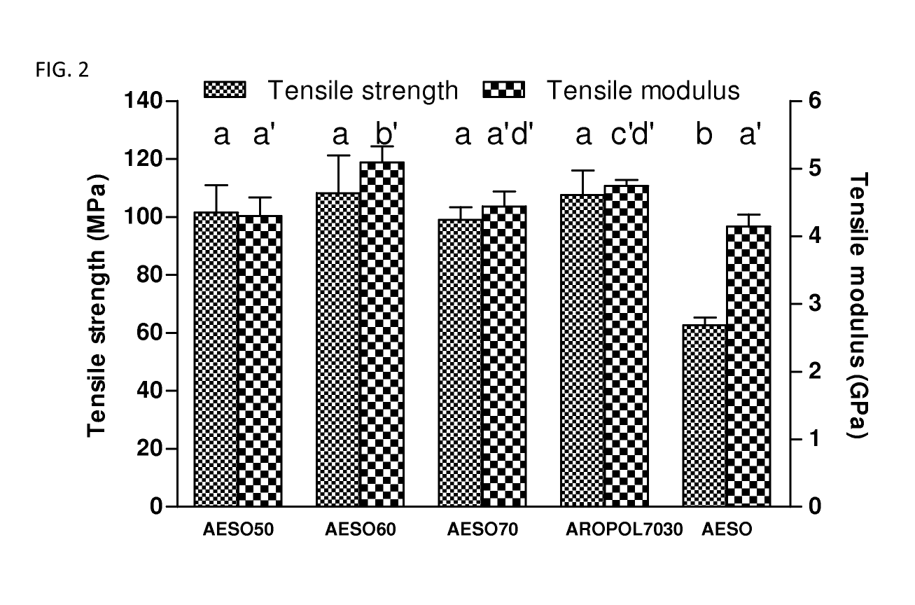

The C═C bonds in methyl cinnamate have greater steric hindrance than those of styrene and cannot efficiently polymerize to form strong polymeric matrixes (C. S. Marvel and G. H. McCain, “Polymerization of Esters of Cinnamic Acid”, Journal of the American Chemical Society, vol. 75, 1953, pp. 3732), which is also supported by the low strengths of the fiber-reinforced methyl cinnamate composites (see FIGS. 1 and 2). It is unexpected that mixtures of methyl cinnamate and a UPE resin are as good as, or even better than a mixture of styrene and the UPE resin in terms of the strengths of the fiber-reinforced composites. It is unexpected that mixtures of two materials (methyl cinnamate and UPE resins) that cannot polymerize/crosslink to form strong polymeric matrixes by themselves are able to synergistically polymerize/crosslink for formation of strong and superior polymeric matrixes. Pure methyl cinnamate has its melting point of 34-38° C. It is unexpected that methyl cinnamate can dissolve UPE resins very well and result in clear, homogeneous solutions with a very low viscosity even at room temperature (ca. 20-25° C.).

Disclosed herein are novel compositions of substantially styrene-free unsaturated polyester resins and methods of using the compositions for production of fiber-reinforced composites. In certain embodiments the compositions include (meth)acrylated vegetable oil(s), unsaturated polyester resin(s), and a free radical initiator. In certain embodiments the compositions include cinnamyl alcohol or an ester of cinnamic acid, unsaturated polyester resin(s) (UPE) and/or vinyl ester resin(s) (VE), and a free radical initiator. In certain embodiments the compositions include methyl cinnamate, vinyl ester resin(s), and a free radical initiator. In certain embodiments the compositions include cinnamyl alcohol or an ester of cinnamic acid, unsaturated polyester resin(s) (UPE) and/or vinyl ester resin(s) (VE), (meth)acrylated vegetable oil(s), and a free radical initiator.

The methods include pre-heating of the composition to a temperature at which the compositions have a low viscosity (e.g., can flow easily for a certain period of time), mixing of the composition with reinforcing fibers, and complete curing of the mixture of the composition and the fibers at an elevated temperature.

In certain embodiments the methods include the preparation of cinnamate (or cinnamyl)-UPE/VE compositions, mixing of the composition with reinforcing fibers, and complete curing of the mixture of the composition and the fibers at an elevated temperature.

In certain embodiments no styrene is used in making the compositions, and no styrene is generated in the preparation or use of the compositions.

Vegetable oils are triglycerides of glycerol and fatty acids extracted from plant materials. Typically, the fatty acids are long chain (C₁₂ to C₂₄ or even longer) materials with multiple double bonds per chain. The vegetable oil can be palm oil, olive oil, canola oil, corn oil, cottonseed oil, soybean oil, linseed oil, rapeseed oil, castor oil, coconut oil, palm kernel oil, rice bran oil, safflower oil, sesame oil, sunflower oil, or other polyunsaturated vegetable oils (both naturally existing and genetically modified), or mixtures thereof.

In compounds with activated C═C bonds acrylate groups can be readily introduced onto fatty chains via at least three methods: 1) direct reactions of acrylic acid with unsaturated vegetable oils in the presence of a strong acid catalyst result in acrylated vegetable oils (AVOs), 2) vegetable oil (e.g., soybean oil) can be readily epoxidized to form epoxidized soybean oil that can readily react with acrylic acid to form acrylated vegetable oils (AVOs) (e.g., acrylated epoxidized soybean oil (AESO)), and 3) the C═C bond in vegetable oils are first converted to a diol (—CH(OH)CH(OH)—) or mono-alcohol (—CH₂CH(OH)— or —CH₂CH(CH₂OH)—) that can further react with acrylic acid/acryloyl chloride/acrylic anhydride to form acrylated vegetable oils (AVOs). AVOs disclosed herein include all modified vegetable oils prepared in accordance with one of the previously described methods Methacrylic acid/methacryloyl chloride/methacrylic anhydride can be used to replace acrylic acid/acryloyl chloride/acrylic anhydride, respectively, in the previously described methods.

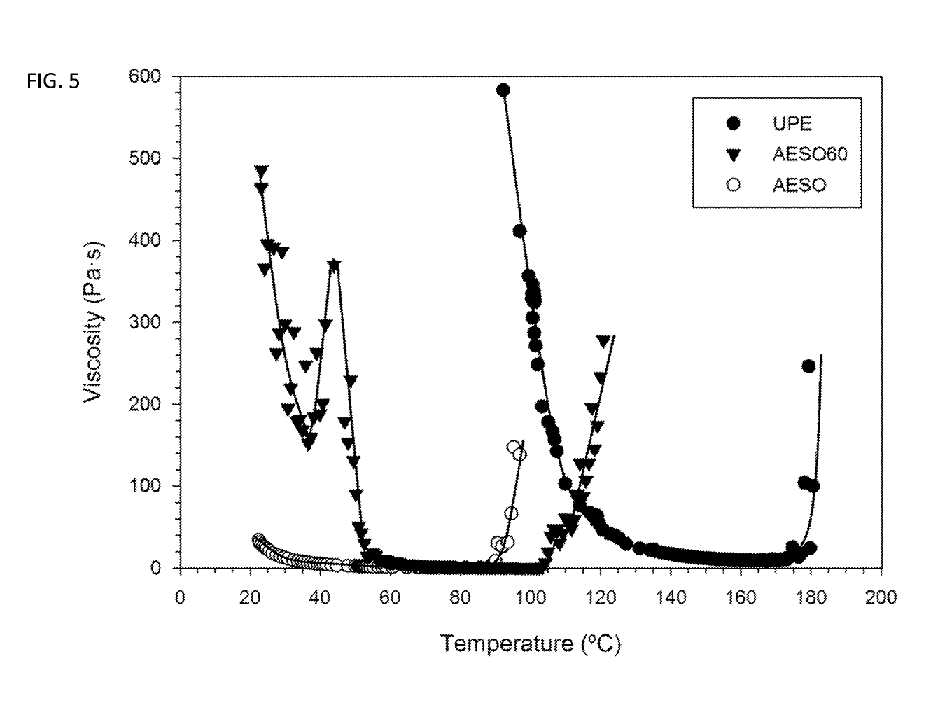

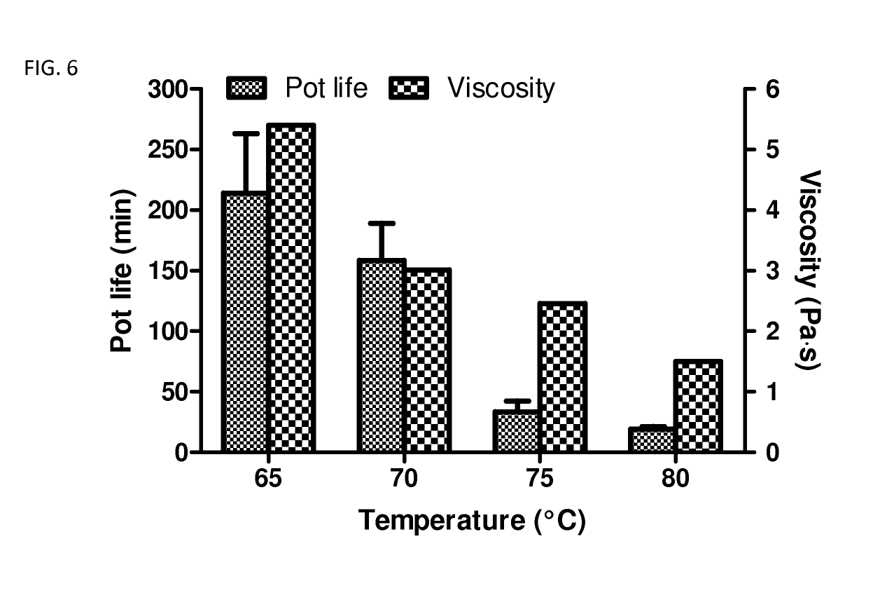

AVO is not a VOC or HAP. There are three long hydrocarbon chains in each AVO molecules and the C═C bonds of acrylate groups in AVO are located inside the long hydrocarbon chains. AESO (˜1260 g/mol) has a higher molecular weight than styrene (104 g/mol). The C═C bonds in AESO have greater steric hindrance than those of styrene and cannot move as freely as styrene for polymerization reactions. The C═C bonds in AESO cannot efficiently polymerize to form strong polymeric matrixes, evidenced by the low strengths of the fiber-reinforced AESO composites (see FIGS. 1 and 2). It is unexpected that mixtures of AVO (e.g., AESO) and a UPE resin are as good as, or even better than a mixture of styrene and the UPE resin in terms of the strengths and water resistance of the fiber-reinforced composites. It is unexpected that mixtures of two materials (AVO (e.g., AESO) and UPE resins) that cannot polymerize/crosslink to form strong polymeric matrixes by themselves are able to synergistically polymerize/crosslink for formation of strong and superior polymeric matrixes. It is also unexpected that AVO (e.g., AESO) can dramatically reduce a working temperature for mixtures of AVO (e.g., AESO), UPE and a free radical initiator when the mixtures are maintained at a very low, but desirable viscosity. For example, the viscosity of the UPE resins was not below 10 Pa·s until it was heated at 160° C., whereas a mixture of 40 wt % UPE resins, 60 wt % AESO, and 1.5 wt % TBPB (tert-butyl peroxybenzoate, the percentage was based on the weights of UPE and AESO) had the viscosity of 10 Pa·s at 56° C. The mixture had the viscosity of as low as 5.4 Pa·s at 65° C. and did not see a significant increase in the viscosity until after 214 min (see FIGS. 5 and 6).

The epoxidized vegetable oils (EVO) may be made from a vegetable oil by converting at least a portion of vegetable oil's double bonds into more reactive epoxy moieties. In particular embodiments, “EVO” generally refers to any derivative of vegetable oils whose double bonds are fully or partly epoxidized using any method, e.g. so called in situ performic acid process, which is the most widely applied process in industry. In certain embodiments, more than one EVO can be utilized in a single mixture if desired. EVOs generally have a functionality (including epoxy groups and possibly hydroxyl groups thereof) well above two. EVOs such as ESO and epoxidized linseed oil are also readily available from commercial suppliers such as Spectrum Chemical Mfg Corp, California, and Sigma-Aldrich Corp, Missouri.

The EVO may contain about 1 to about 9 epoxy groups (or even more) per triglyceride. It is preferred that the EVO contain functionality (epoxy number) of 2 to 7, more preferably 3 to 5. The epoxy functionality of EVO can be controlled by epoxidizing less than all of the double bonds of the starting vegetable oils.

Acrylated epoxidized vegetable oils (AEVO) may be made from the reaction of acrylic acid with EVO. For example, acrylated epoxidized soybean oil (AESO) is made from the reaction of acrylic acid with epoxidized soybean oil (ESO). Methacrylic acid can be used for replacement of acrylic acid in its reaction with EVO to generate methacrylated epoxidized vegetable oils (MEVO). The designation “(meth)acrylate” and similar designations are used as abbreviated notation for “acrylate or methacrylate”.

In the presence of an oxidant such as hydrogen peroxide and a catalyst such as a molybdenum, tungsten, or rhenium-based catalyst, the C═C bond in vegetable oils can be hydroxylated to form a vicinal diol (—CH(OH)CH(OH)—) that can further react with (meth)acrylic acid/(meth)acryloyl chloride/(meth)acrylic anhydride to form (meth)acrylated vegetable oils.

Vegetable oils can also react with formaldehyde in the presence of a catalyst to form hydroxymethylated vegetable oils that can further react with (meth)acrylic acid/(meth)acryloyl chloride/(meth)acrylic anhydride to form (meth)acrylated vegetable oils.

(Meth)acrylated vegetable oils can also be produced through direction reactions of (meth)acrylic acid with unsaturated vegetable oils in the presence of a strong acid.

Vegetable oils can react with acetonitrile in the presence of a strong acid such as sulfuric acid to introduce acrylamide groups onto the C═C bonds via the Ritter reaction.

The ester of cinnamic acid may be, for example, an alkyl or substituted alkyl ester, an unsaturated hydrocarbon ester, or an aromatic ester.

The alkyl group in the alkyl cinnamate may be a branched or unbranched saturated hydrocarbon group, such as methyl, ethyl, n-propyl, isopropyl, n-butyl, isobutyl, t-butyl, pentyl, isoamyl, hexyl, heptyl, octyl, decyl, tetradecyl, hexadecyl, eicosyl, tetracosyl and the like. In certain embodiments, the alkyl is a saturated branched or unbranched hydrocarbon having from 1 to 6 carbon atoms. In preferred embodiments, the alkyl has 1 to 4 carbon atoms such as methyl, ethyl, propyl, and butyl groups.

Other ester groups include, but are not limited to, vinyl, benzyl, allyl, phenethyl, 3-phenylpropyl, linalyl, 4-methoxyphenyl, and cholesteryl.

Unsaturated polyester resins refer to polymers of a dibasic acid (an ester or anhydride of the dibasic acid), a diol, and a dibasic acid (an ester or anhydride of the dibasic acid) containing an activated C═C bond. The dibasic acid/dibasic acid ester/dibasic acid anhydride can be saturated aliphatic dibasic acid/dibasic acid ester/dibasic acid anhydride, and are more typically aromatic dibasic acid/dibasic acid ester/dibasic acid anhydride. The dibasic acids include without limitation malonic acid, succinic acid, glutaric acid, adipic acid, pimelic acid, suberic acid, azelaic acid, sebacic acid, and brassylic acid, phthalic acid, terephthalic acid, isophthalic acid, chlorendic acid, tetrabromophthalic anhydride, tetrachlorophthalic anhydride, and endomethylenetetrahydrophthalic anhydride, and esters and anhydrides of these acids. Preferred saturated dibasic acids include orthophthalic acid, isophthalic acid, terephthalic acid, adipic acid, tetrabromophthalic anhydride, and chlorendic acid. A diol can be any compound containing two hydroxyl groups on each molecule. Illustrative diols include ethylene glycol, propylene glycol, 1,3-propanediol, 1,4-butanediol, diethylene glycol, triethylene glycol, neopentyl glycol, bisphenol A and polyethylene glycol. Preferred diols include ethylene glycol, propylene glycol, diethylene glycol, neopentyl glycol, and bisphenol A.

Dibasic acids containing an activated C═C bond includes fumaric acid, maleic anhydride, maleic acid, esters of fumaric acid or maleic acid, 2-pentenedioic acid, and acetylenedicarboxylic acid. Preferred unsaturated dibasic acids containing an activated C═C bond include maleic anhydride, maleic acid and fumaric acid. The preparation of UPE resins has been extensively studied and reported, e.g., U.S. Pat. No. 1,897,977, U.S. Pat. No. 2,195,362, U.S. Pat. No. 1,897,977 A, U.S. Pat. No. 2,195,362 A, and U.S. Pat. No. 2,255,313.

A free radical initiator system include any system that can generate a free radical for initiating polymerization/crosslinking of C═C bonds in the UPE resins. It typically includes peroxide and azo functional groups. Examples of the peroxide-containing initiators include, but are not limited to, tert-butyl peroxybenzoate, methyl ethyl ketone peroxide, di-tert-butyl peroxide, benzoyl peroxide, cumene hydroperoxide, acetyl acetone peroxide, lauroyl peroxide, tertiary butyl perbenzoate, dicumyl peroxide, cyclohexanol peroxide, methyl isobutyl ketone peroxide, and the like. Examples of the azo-containing initiators include, but are not limited to, azobisisobutyronitrile, 4,4-azobis-4-cyanovalerylic acid, 1-azobis-1-cyclohexane carbonitrile, and related compounds. Two or more initiators can be used in a blend for curing the resin. Ultraviolet light or electron beam may also be used as free radical initiator systems for curing the resins. The free radical initiators can be activated by the action of heat, light, or promoters and accelerators. Examples of promoters and accelerators include, but are not limited to, cobalt naphthenate, cobalt octoate, cobalt acetylacetonates, cobalt octanoate, cobalt acetate, N,N-dimethyl aniline, N,N-diethyl aniline, N,N-dimethyl-2,4,6-trimethylaniline, N,N-di(hydroxypropyl)-2,4,6-trimethyl aniline, vanadium pentoxide, and metal salts from tin, lead, calcium, copper, manganese, rare earth metals, chromium, or sodium.

In certain embodiments (meth)acrylated vegetable oil is mixed with a UPE resins and an initiator at a temperature ranging from 20° C. to 130° C., more particularly from 25° C. to 130° C., and most particularly from 50° C. to 90° C. The AVO/UPE weight ratio ranges from 90/10 to 10/90, more particularly from 70/30 to 40/60. The usage of the initiator is based on the combined weight of AVO and UPE and may range from 0.1 wt % to 13%, more particularly from 1 wt % to 5 wt %.

In certain embodiments, the (meth)acrylated vegetable oil, the UPE resin, and the free radical initiator together constitute at least 50 weight percent, more particularly at least 80 weight percent, of the ingredient composition. In certain embodiments, the (meth)acrylated vegetable oil and the UPE resin are the primary ingredients of the composition in the sense that the (meth)acrylated vegetable oil and the UPE resin together constitute at least 60 weight percent, and more particularly at least 90 weight percent of the ingredient composition. In certain embodiments, the ingredient composition may include less than 50 weight %, more particularly less than 20 weight % of additives, based on the total weight of the ingredient composition. For example, the composition also may include inhibitors such as monomethyl ether hydroquinone; promoters or accelerators such as cobalt naphthenate, cobalt octoate, cobalt acetylacetonates, cobalt octanoate, cobalt acetate, N,N-dimethyl aniline, N,N-diethyl aniline, N,N-dimethyl-2,4,6-trimethylaniline, N,N-di(hydroxypropyl)-2,4,6-trimethyl aniline, vanadium pentoxide, and metal salts from tin, lead, calcium, copper, manganese, rare earth metals, chromium, or sodium; UV absorbers such as 2-hydroxy-4-methoxybenzophenone and 2,4-di-tert-butyl-6-(5-chlorobenzotriazol-2-yl) phenol; thixotropic/flow control agents such as precipitated silica and hydrogenated castor oil; fillers such as calcium carbonate, calcium sulfate, alumina trihydrate, glass and ceramic microballoons, phenolic microballoons, glass microspheres, nepheline syenite, silica sand, clays, dolomites, and talc; thickening agents such as Group II metal (e.g., magnesium and calcium) oxides and hydroxides, and other non-metal thickening systems; and other additives such as pigments and colorants, antioxidants, wetting agents, air bubble release agents, mold release agents, catalyst indicators, flame retardants, wax, etc.

In certain embodiments, the (meth)acrylated vegetable oil and the UPE resin are the only reactive components in the ingredient composition. As used herein, “reactive component” means that the component chemically reacts with another component in the ingredient composition.

In particular embodiments, AVO is mixed with a UPE resins without an initiator at a temperature ranging from 20° C. to 130° C., more particularly 25° C. to 130° C., and most particularly from 50° C. to 90° C., and then cooled to room temperature for long term storage and transportation. Prior to use, an initiator is mixed well with the mixture that has been pre-heated to a second temperature.

In particular embodiments, AVO can be replaced with MVO (methacrylated vegetable oil) in the previously described compositions.

In particular embodiments, the viscosity of the reactant mixture is below 1000 Pa·s, particularly below 500 Pa·s, more particularly below 50 Pa·s, and most particularly below 5 Pa·s at a working temperature from 20° C. to 120° C.

In particular embodiments, the pot life of the reactant mixture is at least 20 min, more particularly at least 220 min.

In certain embodiments UPE resins or VE resins are mixed together with cinnamyl alcohol or an ester of cinnamate. UPE resins or VE resins readily dissolve in cinnamyl alcohol or an ester of cinnamate. The resulting cinnamate (or cinnamyl alcohol)-UPE/VE solution can be stored at a wide range of temperatures for a long time. An initiator is added to the solution prior to use for making fiber-reinforced composites. The cinnamate (or cinnamyl alcohol)/UPE weight ratio or cinnamate (or cinnamyl alcohol)/VE weight ratio ranges from 90/10 to 10/90, more particularly from 70/30 to 20/80, and most particularly from 50/50 to 30/70. The usage of the initiator is based on the combined weight of cinnamate (or cinnamyl alcohol) and UPE, or cinnamate (or cinnamyl alcohol) and VE and may range from 0.1 wt % to 13%, more particularly from 1 wt % to 5 wt %.

In certain embodiments, cinnamate (or cinnamyl alcohol), the UPE resin or VE resin, and the free radical initiator together constitute at least 50 weight percent, more particularly at least 80 weight percent, of the ingredient composition. In certain embodiments, cinnamate (or cinnamyl alcohol) and the UPE resin (or VE resin) are the primary ingredients of the composition in the sense that cinnamate (or cinnamyl alcohol) and the UPE resin (or VE resin) together constitute at least 60 weight percent, and more particularly at least 90 weight percent of the ingredient composition. In certain embodiments, the ingredient composition may include less than 50 weight percent, more particularly less than 20 weight % of additives, based on the total weight of the ingredient composition. For example, the composition also may include inhibitors such as monomethyl ether hydroquinone; promoters or accelerators such as cobalt naphthenate, cobalt octoate, cobalt acetylacetonates, cobalt octanoate, cobalt acetate, N,N-dimethyl aniline, N,N-diethyl aniline, N,N-dimethyl-2,4,6-trimethylaniline, N,N-di(hydroxypropyl)-2,4,6-trimethyl aniline, vanadium pentoxide, and metal salts from tin, lead, calcium, copper, manganese, rare earth metals, chromium, or sodium); UV absorbers such as 2-hydroxy-4-methoxybenzophenone and 2,4-di-tert-butyl-6-(5-chlorobenzotriazol-2-yl) phenol; thixotropic/flow control agents such as precipitated silica and hydrogenated castor oil; fillers such as calcium carbonate, calcium sulfate, alumina trihydrate, glass and ceramic microballoons, phenolic microballoons, glass microspheres, nepheline syenite, silica sand, clays, dolomites, and talc; thickening agents such as Group II metal (e.g., magnesium and calcium) oxides and hydroxides, and other non-metal thickening systems; and other additives such as pigments and colorants, antioxidants, wetting agents, air bubble release agents, mold release agents, catalyst indicators, flame retardants, wax, etc.

In certain embodiments, cinnamate (or cinnamyl alcohol) and the UPE resin (or VE resin) are the only reactive components in the ingredient composition. As used herein, “reactive component” means that the component chemically reacts with another component in the ingredient composition.

In particular embodiments, cinnamate (or cinnamyl alcohol) is mixed with UPE resins (and/or VE resins) to form stable solutions for long term storage and transportation. Prior to use, an initiator is mixed well with the mixture. In certain embodiments, the cinnamate (or cinnamyl alcohol) is mixed with UPE resins (or VE resins) at a temperature of 20° C. to 260° C., more particularly 34° C. to 260° C., and most particularly from 40° C. to 120° C.

In particular embodiments, the viscosity of the reactant mixture is below 500 Pa·s, more particularly below 50 Pa·s, and most particularly below 5 Pa·s at a working temperature from 20° C. to 120° C.

In certain embodiments, cinnamate (or cinnamyl alcohol), the UPE resin or VE resin, and the (meth)acrylated vegetable oil(s) are mixed together. A free radical initiator is added to the mixture prior to use for making fiber-reinforced composites. The weight percentage of each component (cinnamate (or cinnamyl alcohol), UPE (or VE), or AVO (or MVO)) in the resin mixture ranges from 1% to 90%, more particularly from 5% to 95%, most particularly from 10% to 90%, respectively. The usage of the initiator is based on the combined weight of cinnamate (or cinnamyl alcohol)/UPE/(meth)acrylated vegetable oil(s), or cinnamate (or cinnamyl alcohol)/VE/(meth)acrylated vegetable oil(s) and may range from 0.1 wt % to 13%, more particularly from 1 wt % to 5 wt %.

In certain embodiments, cinnamate (or cinnamyl alcohol)/UPE/(meth)acrylated vegetable oil(s) or cinnamate (or cinnamyl alcohol)/VE/(meth)acrylated vegetable oil(s), and the free radical initiator together constitute at least 50 weight percent, more particularly at least 80 weight percent, of the ingredient composition. In certain embodiments, cinnamate (or cinnamyl alcohol), the UPE resin (or VE resin), and the (meth)acrylated vegetable oil(s), are the primary ingredients of the composition in the sense that cinnamate (or cinnamyl alcohol), the UPE resin (or VE resin), and the (meth)acrylated vegetable oil(s), together constitute at least 60 weight percent, and more particularly at least 90 weight percent of the ingredient composition. In certain embodiments, the ingredient composition may include less than 50 weight percent, more particularly less than 20 weight % of additives, based on the total weight of the ingredient composition. For example, the composition also may include inhibitors such as monomethyl ether hydroquinone; promoters or accelerators such as cobalt naphthenate, cobalt octoate, cobalt acetylacetonates, cobalt octanoate, cobalt acetate, N,N-dimethyl aniline, N,N-diethyl aniline, N,N-dimethyl-2,4,6-trimethylaniline, N,N-di(hydroxypropyl)-2,4,6-trimethyl aniline, vanadium pentoxide, and metal salts from tin, lead, calcium, copper, manganese, rare earth metals, chromium, or sodium); UV absorbers such as 2-hydroxy-4-methoxybenzophenone and 2,4-di-tert-butyl-6-(5-chlorobenzotriazol-2-yl) phenol; thixotropic/flow control agents such as precipitated silica and hydrogenated castor oil; fillers such as calcium carbonate, calcium sulfate, alumina trihydrate, glass and ceramic microballoons, phenolic microballoons, glass microspheres, nepheline syenite, silica sand, clays, dolomites, and talc; thickening agents such as Group II metal (e.g., magnesium and calcium) oxides and hydroxides, and other non-metal thickening systems; and other additives such as pigments and colorants, antioxidants, wetting agents, air bubble release agents, mold release agents, catalyst indicators, flame retardants, wax, etc.

In certain embodiments, cinnamate (or cinnamyl alcohol), the UPE resin (or VE resin), and the (meth)acrylated vegetable oil(s), are the only reactive components in the ingredient composition. As used herein, “reactive component” means that the component chemically reacts with another component in the ingredient composition.

In one particular embodiment, cinnamate (or cinnamyl alcohol) and (meth)acrylated vegetable oil(s) are initially mixed together and the UPE resin or VE resin is subsequently dissolved in the resulting cinnamate (or cinnamyl alcohol)/(meth)acrylated vegetable oil(s) mixture. The resulting reactant mixture can form a stable, homogeneous solution. In particular embodiments, the viscosity of the reactant mixture is below 1000 Pa·s, more particularly below 50 Pa·s, and most particularly below 5 Pa·s at a working temperature from 20° C. to 120° C. In certain embodiments, the cinnamate (or cinnamyl alcohol) is mixed with (meth)acrylated vegetable oil(s) at a temperature of 20° C. to 260° C., more particularly from 40° C. to 130° C. In certain embodiments, the resulting cinnamate (or cinnamyl alcohol)/(meth)acrylated vegetable oil(s) mixture is mixed with the UPE resin or VE resin at a temperature of 20° C. to 200° C., more particularly from 40° C. to 130° C.

Reinforcing materials used for composites include fibers, whiskers, and particles. Fibers are the most common reinforcing materials for composites. In certain embodiments composites can be made by combining a reinforcing material, particularly a fibrous material, with the compositions disclosed herein. The reinforcing material, particularly a fibrous material, may be in the form, for example, of a woven or nonwoven web, a multifilament yarn, a monofilament, or flock. The reinforcing material, particularly fibers, may be unidirectionally oriented or randomly oriented. The reinforcing material, particularly fibrous material, may be partially or fully encapsulated by the compositions disclosed herein. In certain embodiments, the composites are fiber-reinforced composites wherein the compositions disclosed herein form the matrix component of the composites.

In particular embodiments, reinforcing fibers are pre-formed into an article of manufacture (e.g., composites such as mats) and the compositions are contacted with the article via pouring or by means of vacuum in a sealed bag. Illustrative form for the reinforcing fibers and/or composites include filaments, strands, tows, roving, yarns, woven and knitted fabrics, non-woven fabrics (e.g., mat), prepregs, braided, stitched and three-dimensional laminates, preforms, hybrids, and whiskers.

The article can be optionally pre-heated to a working temperature. In particular embodiments, the mixtures of fibers and the compositions are compression molded into products with different shapes at a temperature ranging from 50° C. to 210° C., more particularly from 80° C. to 180° C., and most particularly from 135° C. to 160° C. In other embodiments, the mixtures of fibers and the compositions are compression molded into products with different shapes at a temperature ranging from 40° C. to 210° C., more particularly from 60° C. to 180° C., and most particularly from 80° C. to 170° C.

In particular embodiments, illustrative fibers include, but are not limited to, glass fibers, mineral wools, synthetic fibers such as carbon/graphite fibers, Kevlar fibers, nylon fibers, and polyester fibers, natural fibers such as wood fibers, rayon fibers, cotton fibers, kapok fibers, coir fibers, kenaf fiber, hemp fibers, flax fibers, jute fibers, ramie fibers, rattan fibers, vine fibers, corn stalk fibers, rice stalk fibers, wheat stalk fibers, barley stalk fibers, grass fibers, bamboo fibers, banana fibers, sisal fibers, abaca fibers, henequen fibers, sansevieria fibers, fique fibers, agave fibers, wool, goat hair, alpaca hair, horse hair, silk fibers, and feather fibers, metallic fibers such as aluminum fibers, and the like.

### EXAMPLES

### Example 1

### Preparation of Kenaf Fiber Mats

Kenaf fibers (Kenaf Industries Ltd, Raymondville, Tex.) (130 g, 1 inch in length) were fed into a LOUET drum carder for tearing apart fiber bundles and forming unidirectionally oriented kenaf fiber mats through a carding, layering and needle-punching process. The resulting fiber mats were cut by a paper cutter into five mats, with each mat having the dimensions of 200 mm×200 mm×10 mm. The fiber mats were stacked horizontally in an aluminum tray and oven-dried at 103° C. for at least 20 h before use. The weight of five oven-dried fiber mats was 78 g.

### Example 2

### Preparation of AESO/UPE Resin

Acrylated epoxidized soybean oil (AESO) (containing 4,000 ppm monomethyl ether hydroquinone (MEHQ)) (Sigma-Aldrich, St. Louis, Mo.) (71.6 g) was heated to 90° C. in a 250-mL beaker equipped with a mechanical stirrer and an oil bath. Styrene-free unsaturated UPE resins (Ashland Chemical, Columbus, Ohio) (47.7 g) was slowly added into AESO over 5 min. The mixture was allowed to be stirred for 10 min to generate a resin that was homogenous and of low viscosity. The resin was purged with nitrogen for 3 min and cooled to 70° C. TBPB (tert-butyl peroxybenzoate, Akzo Nobel, Chicago, Ill.) (1.83 g, 1.5 wt % of AESO+UPE resin) was added into the resin and the resin was allowed to be stirred for 3 min. The resulting AESO/UPE/TBPB resin contained 60 wt % AESO and was designated as AESO60. AESO50 and AESO70 containing 50 wt % AESO and 70 wt % AESO, respectively, were prepared with the same procedures and both contained 1.5 wt % TBPB based on weights of AESO and UPE. A commercially available styrene-containing UPE resin, AROPOL™ 7030 (a mixture of about 60% unsaturated polyester and 40% styrene, Ashland Chemical, Columbus, Ohio), was mixed with 1.5 wt % of TBPB and used as a control. A mixture of AESO and 1.5 wt % of TBPB (based on the weight of AESO) was also used as a control.

### Example 3

### Preparation of Kenaf-AESO/UPE Composite Panels

AESO60 (7.8 g) was slowly poured onto the upper surface of a kenaf fiber mat that was placed in the chamber of a stainless steel mold having a dimension of 200 mm×200 mm×3 mm. The mat was flipped and subsequently coated with the same amount of resin on the other surface. Afterwards, a second fiber mat was stacked above the first mat with the fiber direction parallel to each other, and subsequently coated with AESO60 on both sides using the same procedures previously described. The same procedures were applied to the rest of the fiber mats. The resin was kept at 70° C. for maintaining its low viscosity for thorough wetting of the fibers. After the resin application, the mold was pressed at 3.5 MPa by an automatic Benchtop Carver press (Carver Inc., Wabash, Ind.) for 10 min at room temperature, and subsequently pressed at 4.5 MPa for 40 min with the temperature rising to 160° C. at about 10° C./min. Afterwards, the mold was placed between two plywood panels and was allowed to slowly cool down under a pressure of 4.5 MPa. After 100 min, the mold was removed from the press and stayed at room temperature overnight. Surface finish of the resulting composite panels was clean and smooth. AESO50 and AESO70 were used for the preparation of composite panels with the same procedures. Kenaf-AROPOL7030 composite panels were prepared with the same procedures, except that the resin was kept at 40° C. during the resin application. Kenaf-AESO composite panels were prepared with the same procedures, except that the resin was kept at 55° C. during the resin application.

### Example 4

### Determination of Flexural Properties of the Kenaf AESO/UPE Composites

The test specimens having a dimension of 65 mm×12.7 mm×3 mm, with the fibers aligning along the lengthwise direction of the specimen, were evaluated for the flexural strength and flexural modulus through a three-point bending test that was performed according to ASTM D790, with a span of 50 mm and a rate of crosshead motion of 1.28 mm/min. Six specimens were tested and averaged values were reported.

The results are shown in FIG. 1. Increasing the AESO content in the AESO/UPE resin from 50 wt % to 60 wt % didn't significantly change the flexural strength, but significantly increased the flexural modulus of the composites. Further increasing the AESO content from 60 to 70 wt % decreased the flexural strength significantly, but didn't result in significant decrease in flexural modulus. Composites prepared from AESO60 had better flexural properties than those from AESO50 and AESO70. Compared to the composites prepared from the commercially available styrene-containing AROPOL™ 7030 resin, the composites prepared from AESO60 had a significantly higher flexural strength and a comparable flexural modulus. The composites made with AESO60 had significantly higher flexural strength and flexural modulus than those with AESO alone. Test results demonstrated that the styrene-free AESO/UPE resin having 60 wt % AESO was superior to the styrene-containing AROPOL™ 7030 resin in terms of the flexural properties of the final composites.

### Example 5

### Determination of Tensile Properties of the Kenaf-AESO/UPE Composites

The tensile strength and tensile modulus were obtained from a tensile test in accordance with ASTM D3039. For the preparation of dumbbell shape specimens for the tensile test, the composite panels were first cut into rectangular specimens with a dimension of 58×14.5 mm×3 mm, with the fibers aligning along the lengthwise direction of the specimen. The rectangular specimens were further cut into dumbbell shape specimens that had a gripping length of 11 mm on each end, a width of the narrow section of 8.5 mm, and a length of the narrow section of 30 mm. The distance between grips was 36 mm, the rate of crosshead motion was 0.5 mm/min, and the time to failure was about 2 min. Six specimens were tested and averaged values were reported.

Results are shown in FIG. 2. Increasing the AESO content from 50 to 60 wt % didn't significantly change the tensile strength, but significantly increased the tensile modulus of the composites. Further increasing the AESO content didn't significantly change the tensile strength, but significantly decreased the tensile modulus. Composites prepared from AESO60 had better tensile properties than those from AESO50 and AESO70. Compared to the composites prepared from the commercially available styrene-containing AROPOL™ 7030, the composites prepared from AESO60 had a comparable tensile strength and a significantly higher tensile modulus. The composites prepared from AESO60 had significantly higher tensile strength and tensile modulus than those from AESO alone. Test results demonstrated that the styrene-free AESO/UPE resin having 60 wt % AESO was superior to the styrene-containing AROPOL™ 7030 resin in terms of the tensile properties of the final composite products.

### Example 6

### Measurements of Water Absorption of the Kenaf-AESO/UPE Composites

The water absorption tests were performed according to ASTM D570. Test specimens had a dimension of 76.2 mm×25.4 mm×3 mm. Prior to the tests, the specimens were dried in an oven for 24 h at 50° C., cooled in a desiccation, and weighed. Subsequently, the specimens were immersed in distilled water. At predetermined intervals, the specimens were removed from water, wiped free of surface moisture with a dry tissue paper, weighed, and replaced in the water. The water absorption was determined by the ratio of the weight gain to the dry weight. Three specimens were tested and averaged values were reported.

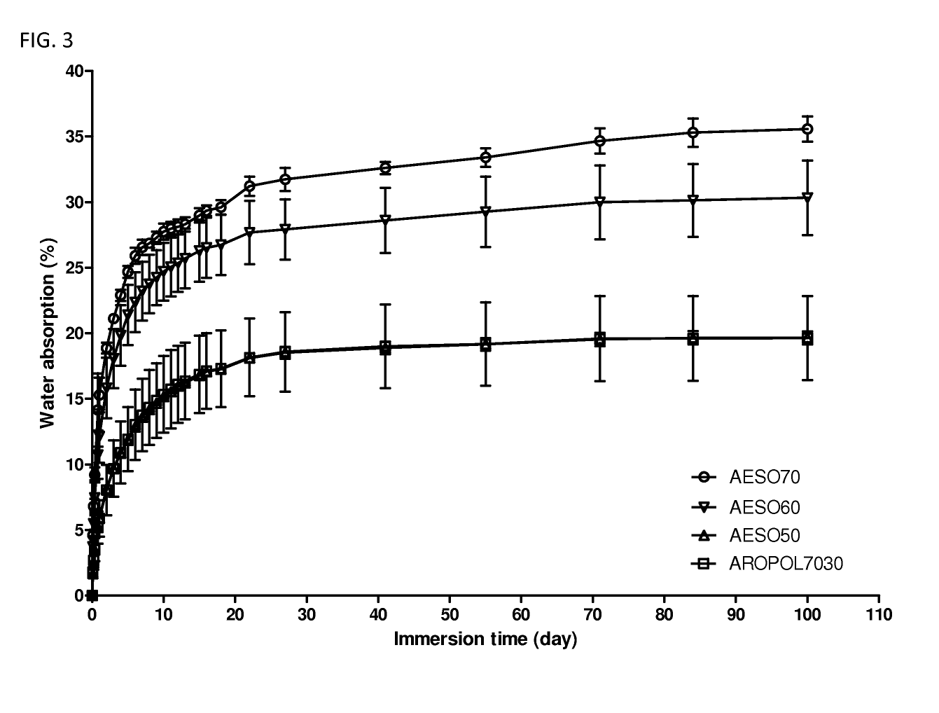

Results are shown in FIG. 3. The water absorption for all the composites increased with increasing immersion time and then leveled out. The composite prepared from AESO50 containing 50 wt % of AESO in the AESO/UPE resin had approximately the same water absorption behavior as the composite prepared from AROPOL™ 7030. As the AESO content increased from 50 to 70 wt %, the water absorption of the resulting composites increased. For a set period of time, a higher water absorption indicates a lower water resistance of a composite. Test results showed that AESO50 was comparable with AROPOL™7030 and better than AESO60 and AESO70 in terms of the water resistance of the composite products.

### Example 7

### Characterization with Differential Scanning Calorimetry (DSC)

DSC experiments were performed on a TA Q2000 analyzer (TA Instruments, Inc., New Castle, Del.). The DSC was calibrated in three steps: the first with nothing in the chamber to get a baseline correction, the second with sapphire to calibrate the heat capacity, and the third with indium for temperature calibration. Nitrogen was used as a purge gas, with a flow rate of 75 mL/min. Test specimen (8.5 mg) in standard aluminum pan with lid was heated from room temperature to 210° C. at a rate of 10° C./min. An empty aluminum pan with a lid was used as a reference. The Universal Analysis 2000 V4.7A software, supplied by TA Instruments, Inc., was used for analyzing the data.

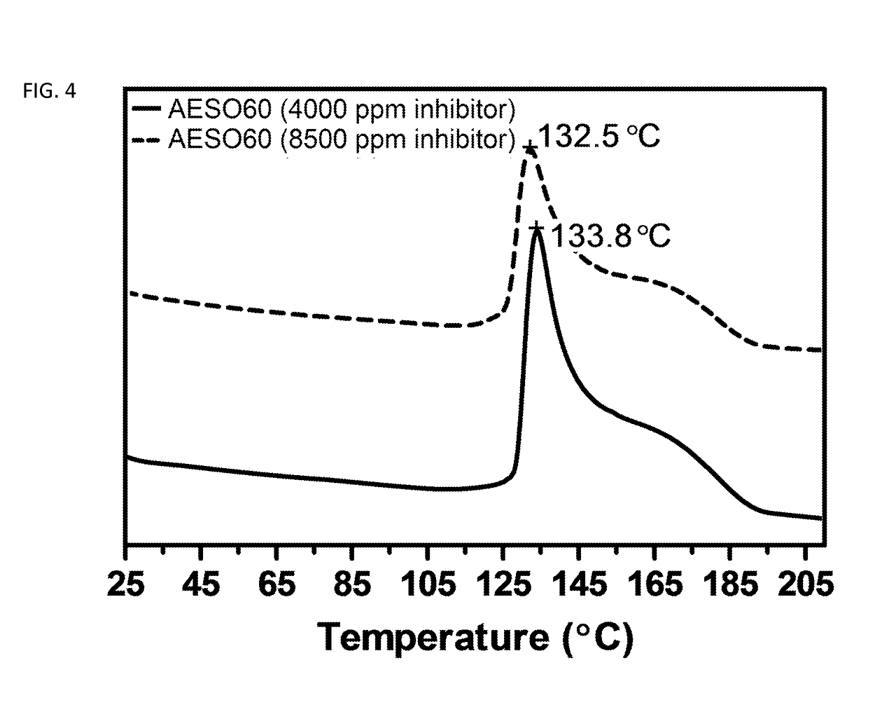

Results are shown in FIG. 4. The exothermal peak for AESO60 (4000 ppm inhibitor) and AESO60 (8500 ppm inhibitor) was 132.5 and 133.8° C., respectively, both of which started at around 110° C. These two exothermal peaks had approximately the same trend, indicating that increasing the concentration of inhibitor from 4000 ppm to 8500 ppm didn't significantly change the curing behavior of the AESO60 resin. Given enough time, a temperature that is higher than the exothermal peak temperature should be able to completely cure the AESO60 resin. A temperature of 160° C. was used as the hot-press temperature in our study.

### Example 8

### Relationship Between the Resin Viscosity and Temperature

The resin viscosity at elevated temperatures was measured with an AR 2000ex Rheometer (TA Instruments, Inc., New Castle, Del.) using 25 mm parallel plate geometry with a gap of 400 μm. Test specimens (0.20 g) were sheared by a steady shear at a shear rate of 5 Hz, from 20 to 130° C. at a rate of 5° C./min, with a sampling delay time of 10 s. The Rheology Advantage Data Analysis (version 5.6.0) software, supplied by TA Instruments, Inc., was used for analyzing the data.

Results are shown in FIG. 5. As the temperature was raised from 23° C. to 60° C., the viscosity of AESO60 dramatically decreased from 465 Pa·s to about 6 Pa·s. The resin viscosity continued to decrease as the temperature increased and then flattened out at between 1 and 3 Pa·s. The viscosity increased five times when the temperature was raised from 103° C. to 104° C. The temperature at which a sudden and significant increase in viscosity was first noticed was defined as the onset temperature for the curing of the AESO/UPE resin in this disclosure. The onset temperature for the curing of AESO60 was therefore 103° C.

The resin viscosity first decreased and then increased from 20 to 50° C., which was probably due to phase separation of the resins; i.e., when heated, the components of the mixture, particularly those close to the furnace, began to melt from a semi-solid state to a liquid state. This probably resulted in a core of viscous semi-solid resins surrounded by a shell of less viscous liquid resins, which explained the initial decrease in viscosity. However, due to the consistent shear motion, the core and shell structure might be broken and the semisolids might begin to disperse in the liquids, resulting in an increase in the viscosity thus measured. As the temperature continued to increase, all the semi-solid resins melted to liquids and the phase separation of the resins disappeared. The viscosity then kept decreasing with increasing the temperature.

### Example 9

### The Pot Life of the AESO/UPE Resins

For the measurement of the pot life of the AESO/UPE resin at use temperatures, a time sweep was performed with an AR 2000ex Rheometer (TA Instruments, Inc., New Castle, Del.) using 25 mm parallel plate geometry with a gap of 400 μm. A test specimen (0.20 g) was sheared by an oscillating shear with a strain amplitude of 50% at 65, 70, 75, and 80° C., respectively. Sampling delay time was set at 10 s. Before curing, the storage modulus (G′) remained almost unchanged over time. As the curing began, G′ started to increase quickly and substantially. The time when the increase in G′ reached 200% of the plateau value was defined as the end of the pot life for the resin in this disclosure. The Rheology Advantage Data Analysis (version 5.6.0) software, supplied by TA Instruments, Inc., was used for analyzing the data.

Results are shown in FIG. 6. The pot life, i.e., the time during which the viscosity of the AESO/UPE resin did not significantly change, decreased along with increasing the temperature, which is consistent with the fact that TBPB decomposes faster at higher temperatures. The pot life of the resin was 214 min at 65° C., and 19 min at 80° C. The resin stability was also affected by the concentration of inhibitor, monomethyl ether hydroquinone (MEHQ). It was found that increasing the concentration of MEHQ from 4000 ppm to 8500 ppm increased the pot life of the resin at 80° C. from 19 min to 60 min. Increasing the concentration of inhibitor is an effective way of increasing the pot life of the resin.

### Example 10

### Preparation of MC/UPE Resin

Methyl cinnamate (MC) (Sigma-Aldrich, St. Louis, Mo.) (40.30 g) was heated to 85° C. in a 250-mL beaker equipped with a mechanical stirrer and an oil bath. Unsaturated polyester (UPE) resins (neat, containing no reactive diluents) (Ashland Chemical, Columbus, Ohio) (60.45 g) was slowly added into MC over 3 min and the mixture was allowed to be stirred for 10 min for complete dissolution of UPE. The resin was clear, homogeneous and had a low viscosity and good flowability at room temperature. The resin was purged with nitrogen for 15 min. TBPB (tert-butyl peroxybenzoate, Akzo Nobel, Chicago, Ill.) (3.00 g, 3.0 wt % based on the MC/UPE resin) was added into the resin and the resin was allowed to be stirred for 3 min. The resulting MC/UPE/TBPB resin contained 40 wt % MC and was designated as MC40. MC30 and MC50 containing 30 wt % MC and 50 wt % MC, respectively, were prepared with the same procedures and both contained 3.0 wt % TBPB based on weights of MC and UPE. A mixture of MC and 3.0 wt % of TBPB (based on the weight of MC), designated as MC100 resin, was used as a control. A commercially available styrene-containing UPE resin, AROPOL™ 7030 (a mixture of about 60% unsaturated polyester and 40% styrene, Ashland Chemical, Columbus, Ohio) was also used as a control.

### Example 11

### Preparation of Kenaf-MC/UPE Composite Panels

MC40 (7.8 g) was slowly dispersed onto the upper surface of a kenaf fiber mat that was placed in the chamber of a stainless steel mold having a dimension of 200 mm×200 mm×3 mm. The mat was flipped and subsequently coated with the same amount of resin on the other surface. Afterwards, a second fiber mat was stacked above the first mat with the fiber direction parallel to each other, and subsequently coated with MC40 on both sides using the same procedures previously described. The same procedures were applied to the rest of the fiber mats. After the resin application, the mold was pressed at 3.5 MPa by an automatic Benchtop Carver press (Carver Inc., Wabash, Ind.) for 10 min at room temperature, and subsequently pressed at 4.5 MPa for 60 min with the temperature rising to 160° C. at about 10° C./min. Afterwards, the mold was placed between two plywood panels and was allowed to slowly cool down under a pressure of 4.5 MPa. After 100 min, the mold was removed from the press and stayed at room temperature overnight. MC30, MC50, MC100 and AROPOL™ 7030 were used for the preparation of composite panels with similar procedures.

### Example 12

### Determination of Flexural Properties of the Kenaf-MC/UPE Composites

The test specimens having a dimension of 65 mm×12.7 mm×3 mm, with the fibers aligning along the lengthwise direction of the specimen, were evaluated for the flexural strength and flexural modulus through a three-point bending test that was performed according to ASTM D790, with a span of 48 mm and a rate of crosshead motion of 1.30 mm/min. Nine specimens were tested and averaged values were reported.

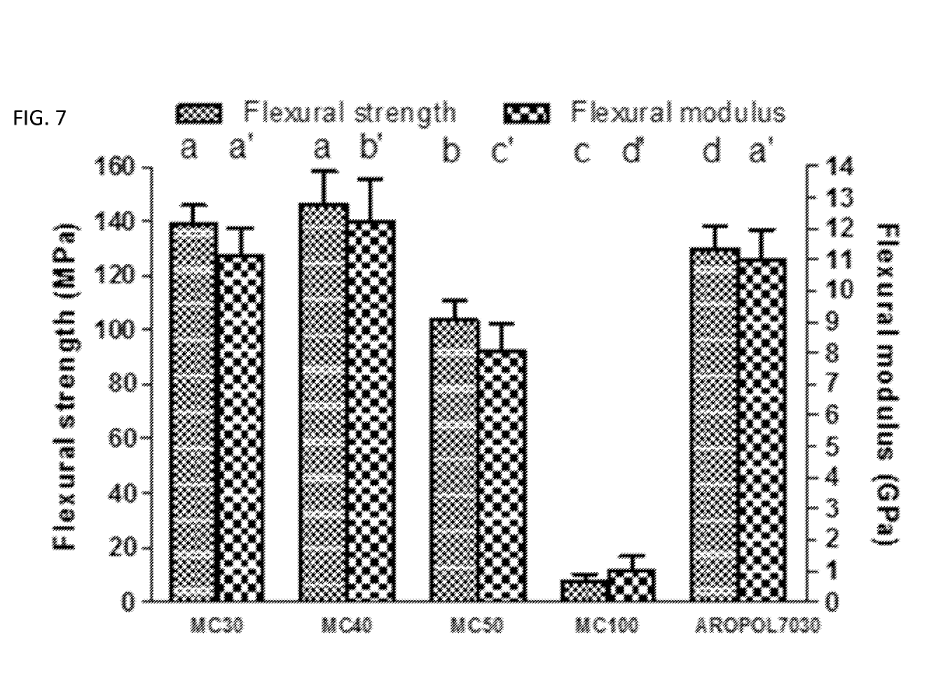

The results are shown in FIG. 7. Increasing the MC content in the MC/UPE resin from 30 wt % to 40 wt % didn't significantly change the flexural strength, but significantly increased the flexural modulus of the composites. Further increasing the MC content from 40 to 50 wt % decreased the flexural strength and the flexural modulus significantly. Composites prepared from MC40 had better flexural properties than those from MC30 and MC50. Compared to the composites prepared from the commercially available styrene-containing AROPOL™ 7030 resin, the composites prepared from MC40 had a significantly higher flexural strength and a comparable flexural modulus. The composites made with MC40 also had significantly higher flexural strength and flexural modulus than those with MC alone (MC100). The very low flexural properties of the composites prepared from MC100 indicated that MC alone cured poorly. Test results demonstrated that the styrene-free MC/UPE resin having 40 wt % MC was superior to the styrene-containing AROPOL™ 7030 resin in terms of the flexural properties of the final composites.

### Example 13

### Determination of Tensile Properties of the Kenaf-MC/UPE Composites

The tensile strength and tensile modulus were obtained from a tensile test in accordance with ASTM D3039. For the preparation of dumbbell shape specimens for the tensile test, the composite panels were first cut into rectangular specimens with a dimension of 58×13 mm×3 mm, with the fibers aligning along the lengthwise direction of the specimen. The rectangular specimens were further cut into dumbbell shape specimens that had a gripping length of 12.5 mm on each end, a width of the narrow section of 6.5 mm, and a length of the narrow section of 28.0 mm. The distance between grips was 33.0 mm, the rate of crosshead motion was 0.5 mm/min, and the time to failure was between 1 to 2 min. Six specimens were tested and averaged values were reported.

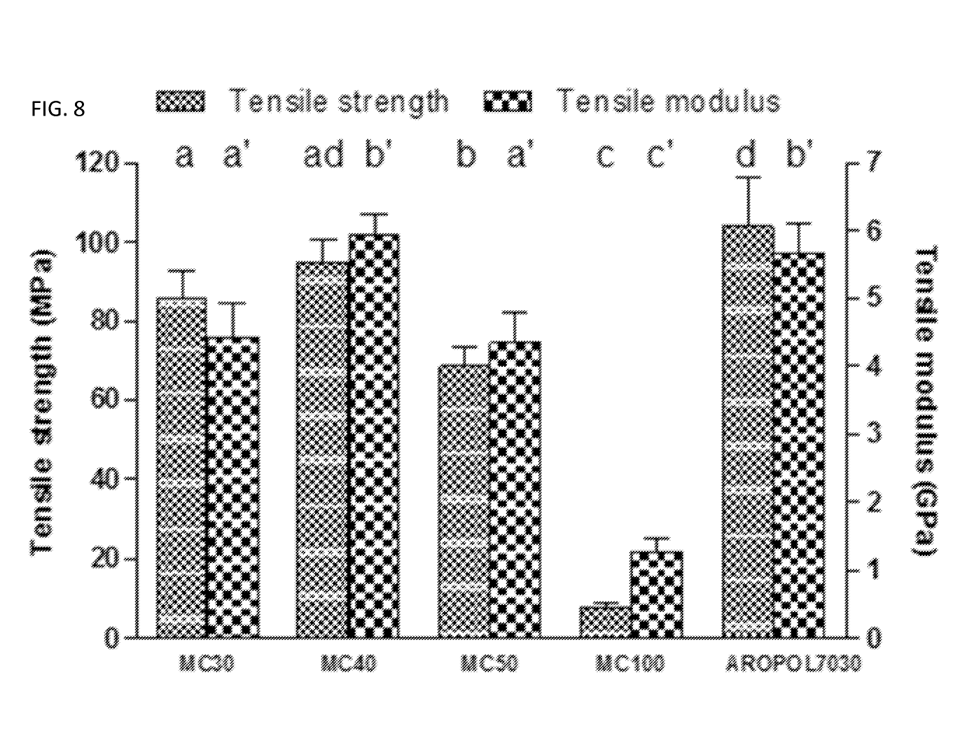

Results are shown in FIG. 8. Increasing the MC content from 30 to 40 wt % didn't significantly change the tensile strength, but significantly increased the tensile modulus of the composites. Further increasing the MC content from 40% to 50% significantly decreased the tensile strength and the tensile modulus. Composites prepared from MC40 had better tensile properties than those from MC30 and MC50. Compared to the composites prepared from the commercially available styrene-containing AROPOL™ 7030, the composites prepared from MC40 had comparable tensile strength and tensile modulus. The composites prepared from MC40 had significantly higher tensile strength and tensile modulus than those from MC alone. Test results demonstrated that the styrene-free MC/UPE resin having 40 wt % MC was comparable to the styrene-containing AROPOL™ 7030 resin in terms of the tensile properties of the final composite products.

### Example 14

### Preparation of AESO/MC/UPE Resin

The mixture of acrylated epoxidized soybean oil (AESO) (containing 4,000 ppm monomethyl ether hydroquinone; Sigma-Aldrich, St. Louis, Mo.) (120.8 g) and methyl cinnamate (MC) (Sigma-Aldrich, St. Louis, Mo.) (13.44 g) was heated to 90° C. in a 600-mL beaker equipped with a mechanical stirrer and an oil bath. Unsaturated polyester (UPE) plastic (neat, containing no reactive diluents) (Ashland Inc., Dublin, Ohio) (89.6 g) was slowly added into the AESO/MC mixture over 20 min with proper stirring. The combined mixture was allowed to be stirred for 10 min at 90° C. for complete dissolution of UPE plastic. The resulting resin was homogenous and had a low viscosity. Prior to resin application, the resin was purged with nitrogen for 5 min and cooled to 70° C. Subsequently, TBPB (tert-butyl peroxybenzoate, Akzo Nobel, Chicago, Ill.) (6.7 g, 3 wt % of AESO/MC/UPE resin) was added into the resin and the resin was allowed to be stirred for 3 min. This resin was designated as (A90M10)60, in which the weight ratio of AESO to MC was 90:10 and the weight ratio of (AESO+MC) to UPE plastic was 60:40. A commercially available styrene-containing UPE resin, AROPOL™ 7030 (Ashland Inc., Dublin, Ohio), was mixed with 3 wt % of TBPB and used as a control. AESO60, which is a mixture of AESO and UPE, and is disclosed in U.S. Provisional Patent Applications (No. 61/968,981) filed Mar. 21, 2014, was also used as a control. In AESO60, the weight ratio of AESO and UPE plastic was 60:40 and the usage of TBPB was 3 wt % of the weight of (AESO+UPE plastic).

### Example 15

### Preparation of Fiberglass Reinforced AESO/MC/UPE Composite Panels

The reinforcement used for this study was fiberglass, in the form of chopped strand mat (Ashland Inc., Dublin, Ohio). Each layer of fiberglass mat had a dimension of 200 mm×200 mm and a total of four layers (about 68 g) were used. The fiberglass mats were impregnated with resins by a hand lay-up process. Specifically, the (A90M10)60 resin (25-30 g) was evenly dispersed onto the upper surface of a fiberglass mat by a spoon. The mat was then flipped over and the other surface was impregnated with the same amount of resin. A second fiberglass mat was stacked above the first mat and was applied with resins using the same procedures previously described. The same procedures were applied to the rest of the fiberglass mats. After the resin application, for removing the air inside the resin-impregnated fiberglass mats, the mats were placed onto a hot plate (70-80° C.) and rolled by a rubber roller by hand for about 5 min. Afterwards, the mats were placed into a stainless steel mold. The mold was first pressed at 4 MPa by an automatic Benchtop Carver press (Carver Inc., Wabash, Ind.) at 50° C. for 10 min, and subsequently pressed at the same pressure for 60 min with the temperature rising to 160° C. at about 10° C./min. Afterwards, the mold was taken out from the press and cooled down at room temperature overnight. The resulting composite panel had a weight of about 152 g (excessive resins flowed out of the mold during the pressing process) and a dimension of 200 mm×200 mm×2.5 mm. The fiber content was calculated to be about 45% by weight.

Fiberglass-reinforced AESO60 composites were prepared with the same procedures as described previously. Fiberglass-reinforced AROPOL™ 7030 composites were prepared with the same procedures, except that the resin was applied at room temperature and the initial 10-min press of the mold was conducted at room temperature instead of 50° C. The control panels also had a weight of about 152 g and a dimension of 200 mm×200 mm×2.5 mm.

### Example 16

### Determination of Flexural Properties of the Fiberglass-AESO/MC/UPE Composites

The test specimens having a dimension of 65 mm×12.7 mm×2.5 mm were evaluated for the flexural strength and flexural modulus through a three-point bending test with a span of 40 mm and a rate of crosshead motion of 1.28 mm/min in accordance with ASTM D790. At least twelve specimens were tested and averaged values were reported.

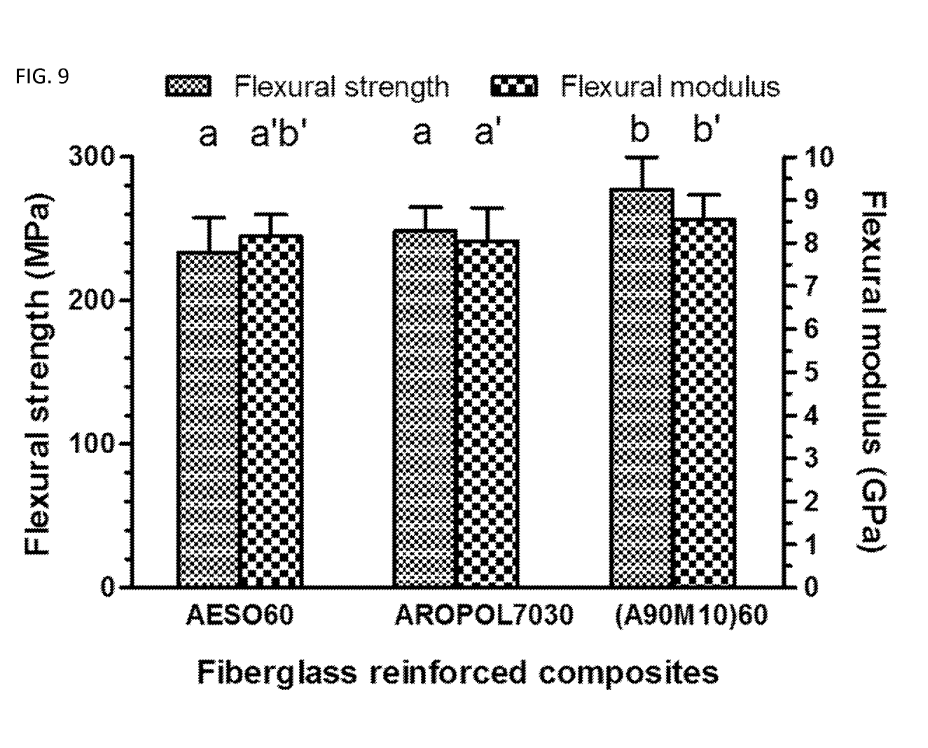

The results are shown in FIG. 9. The fiberglass-AESO60 composites had comparable flexural strength and flexural modulus with the fiberglass-AROPOL™ 7030. The fiberglass-(A90M10)60 composites had significantly higher flexural strength and flexural modulus than the fiberglass-AROPOL™ 7030 composites. The flexural strength of the fiberglass-(A90M10)60 composites was significantly higher than that of the fiberglass-AESO60 composites; but the flexural modulus between these two composites were comparable with each other. Test results demonstrated that the styrene-free (A90M10)60 resin was superior to the styrene-containing AROPOL™ 7030 resin in terms of the flexural properties of the fiberglass reinforced composites.

### Example 17

### Measurements of AESO/MC/UPE Resin Viscosity

The resin viscosity was measured with an AR 2000ex Rheometer (TA Instruments, Inc., New Castle, Del.) using a cone-and-plate geometry (cone angle: 1 degree 59 min 17 sec; cone diameter: 40 mm; truncation gap 52 micro m). The resin samples were sheared at 25° C. with steady state flow at a shear rate of 1 Hz.

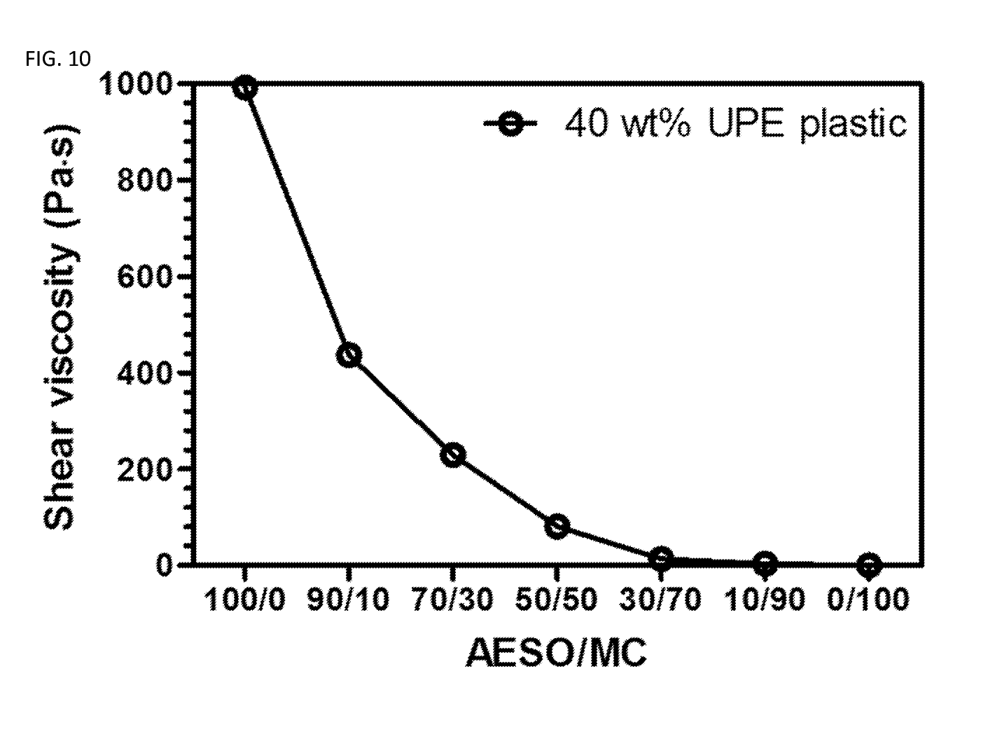

The results are shown in FIG. 10. AESO60 was semi-solid and had a shear viscosity of about 990 Pa·s. Increasing the weight percentage of MC quickly reduced the resin viscosity. The (A90M10)60 resin containing a small amount of MC (6 wt %) already had a much lower viscosity (430 Pa·s) than AESO60 (990 Pa·s).

It is unexpected that the introduction of an alkyl cinnamate (or cinnamyl alcohol into an AVO/UPE (or AVO/VE) resin not only significantly increases the mechanical properties of the resulting composites (see FIG. 9), but also significantly lowers the resin viscosity (see FIG. 10). The styrene-free AVO/cinnamate/UPE (or AVO/cinnamate/VE) resins are superior to the commercially available styrene-containing AROPOL™ 7030 resin in terms of the mechanical properties of the composites (see FIG. 9).

In view of the many possible embodiments to which the principles of the disclosed compositions, composites and methods may be applied, it should be recognized that the illustrated embodiments are only preferred examples of the invention and should not be taken as limiting the scope of the invention.

1. A reaction product of:
(a) at least one cinnamyl alcohol or ester of cinnamic acid;
(b) at least one unsaturated polyester resin, or at least one vinyl ester resin, or a mixture of an unsaturated polyester resin and a vinyl ester resin;
(c) at least one (meth)acrylated vegetable oil; and
(d) a free radical initiator system.

2. A reaction product of:
(a) at least one (meth)acrylated vegetable oil;
(b) at least one unsaturated polyester resin, or at least one vinyl ester resin, or a mixture of an unsaturated polyester resin and a vinyl ester resin; and
(c) a free radical initiator system.

3. A reaction product of:
(a) at least one cinnamyl alcohol or ester of cinnamic acid;
(b) at least one unsaturated polyester resin, or at least one vinyl ester resin, or a mixture of an unsaturated polyester resin and a vinyl ester resin; and
(c) a free radical initiator system.

4. The product of claim 1, wherein the (meth)acrylated vegetable oil comprises (meth)acrylated soybean oil.

5. The product of claim 1, wherein the (meth)acrylated vegetable oil comprises acrylated epoxidized soybean oil.

6. The product of claim 1, wherein the unsaturated polyester resin comprises a reaction product of (a) at least one saturated dibasic acid, (b) at least one diol, and (c) at least one unsaturated dibasic acid.

7. The product of claim 1, wherein the vinyl ester resin comprises a reaction product of (a) at least one epoxy resin, and (b) at least one unsaturated carboxylic acid.

8. The product of claim 1, wherein the free radical initiator system includes peroxide and azo functional groups, and optionally at least one promoter or accelerator.

9. The product of claim 1, wherein the unsaturated polyester resin or vinyl ester resin is styrene-free.

10. The product of claim 1, wherein the product is styrene-free.

11. The product of claim 1, wherein the product is hazardous air pollutant (HAP)-free.

12. The product of claim 2, wherein the (meth)acrylated vegetable oil and the unsaturated polyester resin, or the vinyl ester resin, are the only reactive components.

13. The product of claim 3, wherein (a) and (b) are the only reactive components.

14. The product of claim 1, wherein (a), (b) and (c) are the only reactive components.

15. The product of claim 2, wherein the composition includes at least 60 weight percent of (a) and (b) combined, based on total weight of the composition.

16. The product of claim 1, wherein the composition includes at least 60 weight percent of (a), (b) and (c) combined, based on total weight of the composition.

17. A composition comprising:
(a) at least one (meth)acrylated vegetable oil;
(b) at least one unsaturated polyester resin, or at least one vinyl ester resin, or a mixture of an unsaturated polyester resin and a vinyl ester resin; and
(c) a free radical initiator system.

18. A composition comprising:
(a) at least one cinnamyl alcohol or ester of cinnamic acid;
(b) at least one unsaturated polyester resin, or at least one vinyl ester resin, or a mixture of an unsaturated polyester resin and a vinyl ester resin; and
(c) a free radical initiator system.

19. A composition comprising:
(a) at least one cinnamyl alcohol or ester of cinnamic acid;
(b) at least one unsaturated polyester resin, at least one vinyl ester resin, or a mixture of an unsaturated polyester resin and a vinyl ester resin;
(c) at least one (meth)acrylated vegetable oil; and
(d) a free radical initiator system.

20. (canceled)

21. A composite comprising a fibrous material and the reaction product of claim 1.

22. A composite comprising a fibrous material and the reaction product of claim 2.

23. A composite comprising a fibrous material and the reaction product of claim 3.

24-26. (canceled)

27. A method for making a product comprising mixing together:
(a) at least one (meth)acrylated vegetable oil; and
(b) at least one unsaturated polyester resin, or at least one vinyl ester resin, or a mixture of an unsaturated polyester resin and a vinyl ester resin
in the presence of a free radical initiator system.

28-29. (canceled)

30. A method for making a composite comprising combining:
(a) at least one (meth)acrylated vegetable oil;
(b) at least one unsaturated polyester resin, or at least one vinyl ester resin, or a mixture of an unsaturated polyester resin and a vinyl ester resin;
(c) a free radical initiator system; and
(d) a fibrous material.

31. (canceled)

32. The method of claim 27, wherein the method is styrene-free.

33. A method for making a product comprising contacting:
(a) at least one cinnamyl alcohol or ester of cinnamic acid;
(b) at least one unsaturated polyester resin, or at least one vinyl ester resin, or a mixture of an unsaturated polyester resin and a vinyl ester resin; and
(c) a free radical initiator system.

34-35. (canceled)

36. A method for making a composite comprising combining:
(a) at least one cinnamyl alcohol or ester of cinnamic acid;
(b) at least one unsaturated polyester resin, or vinyl ester resin, or a mixture of an unsaturated polyester resin and a vinyl ester resin;
(c) a free radical initiator system; and
(d) a fibrous material.

37. (canceled)

38. The method of claim 33, wherein the method is styrene-free.

39. (canceled)

40. A method for making a product comprising contacting:
(a) at least one cinnamyl alcohol or ester of cinnamic acid;
(b) at least one unsaturated polyester resin, or at least one vinyl ester resin, or a mixture of an unsaturated polyester resin and a vinyl ester resin;
(c) at least one (meth)acrylated vegetable oil; and
(d) a free radical initiator system.

41. (canceled)

42. A method for making a composite comprising combining:
(a) at least one cinnamyl alcohol or ester of cinnamic acid;
(b) at least one unsaturated polyester resin, or vinyl ester resin, or a mixture of an unsaturated polyester resin and a vinyl ester resin;
(c) at least one (meth)acrylated vegetable oil;
(d) a free radical initiator system; and
(e) a fibrous material.

43. (canceled)

44. The method of claim 40, wherein the method is styrene-free, and hazardous air pollutant (HAP)-free.

45. A reaction product of:
(a) at least one (meth)acrylated vegetable oil;
(b) at least one unsaturated polyester resin; and
(c) a free radical initiator system.
